(19) United States
(12) Patent Application Publication
(10) Pub. No.: US 2010/0091063 A1
(43) Pub. Date: Apr. 15, 2010

(54) LIQUID DROP DISCHARGE HEAD INSPECTING DEVICE AND LIQUID DROP DISCHARGE DEVICE

(75) Inventor: Takeshi Nagata, Osaka-Shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/449,044

(22) PCT Filed: Jan. 17, 2008
(86) PCT No.: PCT/JP2008/050513

§ 371 Date: Jul. 21, 2009

(30) Foreign Application Priority Data
Jan. 22, 2007 (JP) 2007-011055

(51) Int. Cl. B41J 29/393; G01N 21/00

(52) U.S. Cl. 347/19; 356/440

(57) ABSTRACT

This ink jet application device (10) includes an optical sensor (20) and a control unit (30) . The optical sensor (20) has a light emission unit (32) which emits a detection beam (100) so as to intersect the path of travel of liquid drops, and a light reception unit (34) which receives this detection beam (100). The optical sensor (20) performs emission and reception of the detection beam (100) in at least a first position in which a portion of the detection beam (100) is intercepted by a nozzle plate (26), and a second position which is positioned lower than the nozzle plate (26) by just a distance which corresponds to the gap between the nozzle plate (26) and an object to be processed. And, on the basis of the state of light reception by the light reception unit (34), the control unit (30) detects the presence or absence of an obstruction between the light emission unit (32) and the light reception unit (34).

### TECHNICAL FIELD

The present invention relates to a liquid drop discharge head inspecting device and to a liquid drop discharge device, which are capable of inspecting a liquid drop discharge head which discharges liquid drops towards an object to be processed via a nozzle hole provided in the surface of a nozzle.

### BACKGROUND ART

As one example of a capability demanded from a liquid drop discharge device which exploits ink jet technology, there may be cited the requirement to discharge liquid drops in a stable manner over a long period of time. In order to satisfy this demand, in the prior art, measures are adopted for impacting the liquid drops at accurate locations, and for detecting foreign matter which has adhered to the discharge surface of the liquid drop discharge head.

For example, among the prior art techniques, there is one in which a sensor is provided which detects the state of ink adherence to the orifice surface of the head, and in which inaccurate impacting of ink is prevented by controlling the application of ink to the recipient material on the basis of information obtained from that sensor (for example, refer to Patent Document #1). Furthermore, there is a technique in which, if some body is detected which passes through the head between a light emission unit and a light reception unit without ink being discharged, then the operator is notified that some junk is adhered at that position (for example, refer to Patent Document #2).

Moreover, among prior art ink jet printing devices, there is one which is equipped with a light emission unit which emits an optical beam that passes through the ink which is discharged by the print head at a slanting angle with respect to the row of nozzles of the print head, and a light reception unit which detects whether or not ink droplets or ink adhered to the head discharge orifice surfaces have passed through this beam (for example, refer to Patent Document #3).

Patent Document #1: Japanese Laid-Open Patent Publication 2000-15838.

Patent Document #2: Japanese Laid-Open Patent Publication Heisei 11-179934.

Patent Document #3: Japanese Laid-Open Patent Publication 2001-54954.

### DISCLOSURE OF INVENTION

### Problems to be Solved by the Invention

With the inventions according to Patent Documents 1 through 3 described above, although it is possible to detect poor discharge from the liquid drop discharge head in an appropriate manner, sometimes it happens that it is not possible to detect adherence of foreign matter to the discharge surface of the liquid drop discharge head properly. The reason for this is that, if such foreign matter which has adhered to the discharge surface of the liquid drop discharge head is small, sometimes it is the case that the presence of this foreign matter is not reflected in the result of detection by the detection unit.

On the other hand, since there is a fear that foreign matter which has adhered to the discharge surface of the liquid drop discharge head may increase greatly in size due to drying of liquid drops adhered to the discharge surface, accordingly it is very important to eliminate foreign matter at as early a stage as possible. Due to this, it is considered to be very important to detect even small particles of foreign matter adhered to the discharge surface of the liquid drop discharge head in an appropriate manner.

However, separate provision of a detection unit which is dedicated to detecting small particles of foreign matter adhered to the discharge surface of the liquid drop discharge head makes the structure of the liquid drop discharge head inspecting device and of the liquid drop discharge device more complicated, and, as a result, it is impossible to avoid a tendency to increase of the production costs of these devices.

The object of the present invention is to provide a liquid drop discharge head inspecting device and a liquid drop discharge device, which are capable, with a simple structure, of appropriately detecting both poor discharge of the liquid drops, and adherence of foreign matter to the discharge surface.

### Means for Solving Problem

The liquid drop discharge head inspecting device and the liquid drop discharge device of the present invention include a detection unit and a control unit.

The detection unit includes a light emission unit which emits a detection beam so as to intersect the path of progression of the liquid drops, and a light reception unit which receives the detection beam. The detection unit is adapted to perform emission and reception of the detection beam in at least a first position and a second position. Here, the first position is a position in which a portion of the detection beam is intercepted by the nozzle surface. Moreover, the second position is a position which is positioned lower than the nozzle plate by just a distance which corresponds to the gap between the nozzle plate and an object to be processed. As an example of a structure for performing emission and reception of the detection beam in the first position and the second position, it may be suggested to use a mechanism which supports at least one of the light emission unit or the light reception unit so that it can be freely raised and lowered. If the diameter of the beam emitted by the light emission unit is sufficiently large or the area of the light reception surface of the light reception unit is sufficiently large, then it becomes unnecessary to raise and lower the light emission unit or the light reception unit. If, although the diameter of the beam emitted by the light emission unit is sufficiently large, the area of the light reception surface of the light reception unit is not sufficiently large, then it will be sufficient to support only the light reception unit so that it can be freely raised and lowered. On the other hand if, although the area of the light reception surface of the light reception unit is sufficiently large, the diameter of the beam emitted by the light emission unit is not sufficiently large, then it will be sufficient to support only the light emission unit so that it can be freely raised and lowered.

The control unit is adapted to decide upon the presence or absence of obstruction between the light emission unit and the light reception unit, on the basis of the state of light reception by the light reception unit. As examples of bodies which may be detected, liquid drops which are discharged from the liquid drop discharge head, and foreign matter which is adhered to the liquid drop discharge head, may be cited. If an obstruction is detected between the light emission unit and the light reception unit in the first position, then it is considered that this body is foreign matter which has adhered to the nozzle surface or a liquid drop which is passing along the predetermined path of progression. And if, at this time, discharge of liquid drops by the liquid drop discharge head is not being performed, then it may be decided that this body is foreign matter which has adhered to the nozzle surface.

Moreover, if an obstruction is detected between the light emission unit and the light reception unit in the second position, then it may be decided that this body is a liquid drop which is passing along the predetermined path of progression. And if nobody is detected in the second position, irrespective of whether or not the liquid drop discharge head is discharging liquid drops, then it may be decided that the nozzle hole of the liquid drop discharge head is blocked, or that liquid drops are being discharged in a direction which is deviated from the predetermined path of progression.

### EFFECTS OF THE INVENTION

According to the present invention, with a simple structure, it is possible appropriately to detect both poor discharge of the liquid drops, and adherence of foreign matter to the discharge surface.

### BRIEF DESCRIPTION OF THE DRAWINGS

FIG. 1 is a figure showing the external appearance and the general structure of an ink jet application device;

FIG. 2 shows this ink jet application device during the detection of poor liquid drop discharge;

FIG. 3 shows this ink jet application device during the detection of foreign matter;

FIG. 4 is a block diagram showing the general structure of this ink jet application device;

FIG. 5 is a flowchart showing operational steps performed by a control unit;

FIG. 6 is a figure showing an ink jet head during the detection of foreign matter; and

FIG. 7 is a figure showing another example of an ink jet application device.

### EXPLANATION OF REFERENCE NUMBERS

10—ink jet application device
12—stage
14—ink jet head
16—head support unit
18—maintenance unit
26—nozzle plate
30—control unit
40—support unit

### BEST MODE FOR CARRYING OUT THE INVENTION

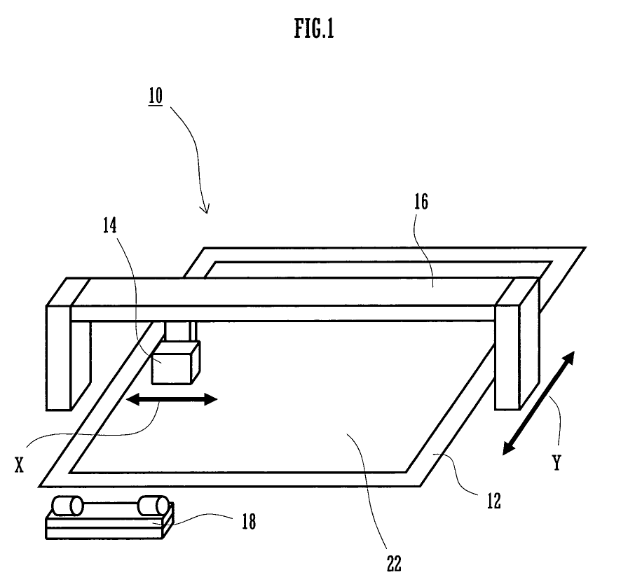

The general structure of an ink jet application device 10 will now be explained using FIG. 1. This ink jet application device 10 has a stage 12 which supports, from underneath, a substrate 22 which is a subject to be processed. This stage 12 is built so as to perform fixation of the substrate 22 by suction against the rear surface of the substrate 22. However, this method for the stage 12 to support the substrate 22 is not limitative.

An ink jet head 14 is disposed above the stage 12. The distance between the upper surface of the substrate 22 and the nozzle surface of the ink jet head 14 is adjusted so as to assume a value which is prescribed in advance. As examples of techniques for this adjustment, adjustment of the height of the ink jet head 14 or adjustment of the height of the stage may be considered. The ink jet head 14 discharges ink towards the substrate 22. And the ink jet head 14 is supported by a head support unit 16. This head support unit 16 supports the ink jet head 14 so that it can shift freely in the direction shown by the arrow X over the stage 12. Moreover, the head support unit 16 is made so as to shift freely in the direction shown by the arrow Y. Due to this, the ink jet head 14 is shiftable to any desired spot over the stage 12.

Near to the stage 12, there is provided a maintenance unit 18 for performing suction and cleaning of the nozzle surface of the ink jet head 14. This maintenance unit 18 is endowed with the functions of testing for non-discharge from the ink jet head 14, and of performing testing for foreign matter which has adhered to the nozzle surface.

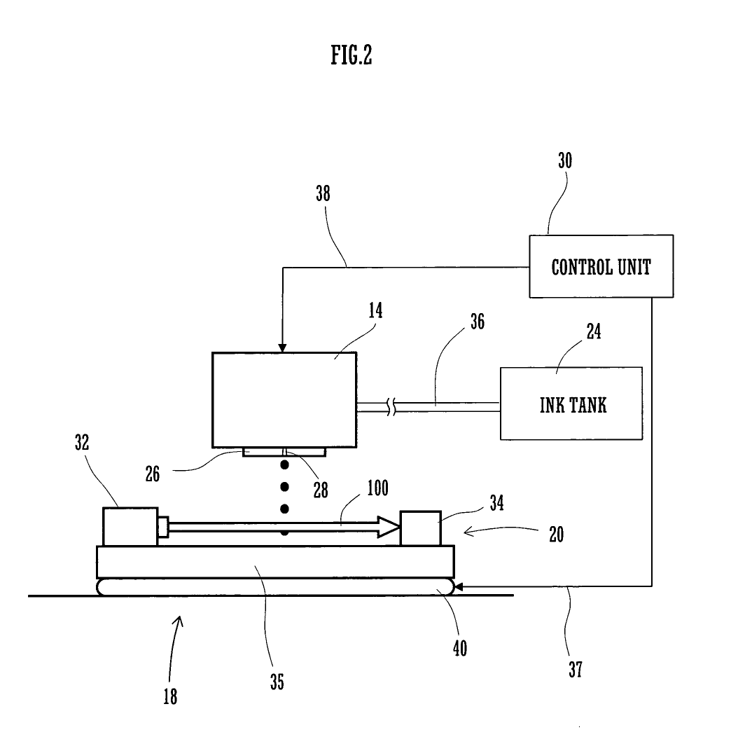

The operation of testing for non-discharge from the ink jet head 14 by the maintenance unit 18 will now be explained using FIG. 2. The ink jet head 14 is equipped with a nozzle plate 26 which has a nozzle hole 28. The ink jet head 14 is connected to a control unit 30 via a signal line 38. By supplying a drive signal to the ink jet head 14, the control unit 30 causes ink to be discharged from the nozzle hole 28. Moreover, the ink jet head 14 is connected to an ink tank 24 via an ink supply pipe 36.

On the other hand, the maintenance unit 18 comprises a stand 35, an optical sensor 20, and a support unit 40. The stand 35 supports the optical sensor 20 from underneath. And the optical sensor 20 comprises a light emission unit 32 and a light reception unit 34. The light emission unit 32 emits a detection light beam 100 of a predetermined beam diameter, so as to intersect the path of progression of the ink. And the light reception unit 34 receives this detection light beam 100 emitted by the light emission unit 34. The light emission unit 32 and the light reception unit 34 are disposed so that a gap is provided between them which is at least larger than the width of the ink jet head 14, so that a detection region is defined between them. When some body such as a liquid drop or a morsel of foreign matter is present within this detection region, the detection beam 100 is interrupted by this body, and as a result the state of reception of light by the light reception unit 34 changes. As examples of decision parameters for the light reception state, the light intensity, the width over which light is detected, the area over which light is detected, or the like, may be cited. In this embodiment, a LX2-100 made by the Keyence company is used as the optical sensor 20.

The support unit 40 supports the stand 35 so that it can be freely raised and lowered. In concrete terms, the support unit 40 shifts the light emission unit 32 and the light reception unit 34 between a first position and a second position. The first position is a position in which a portion of the detection beam 100 is interrupted by the nozzle plate 26. Arranging for a portion of the detection beam 100 to be interrupted by the nozzle 26 is in order to make it possible to detect a small morsel of foreign matter which has adhered to the nozzle plate 26. And the second position is a position lower than the nozzle plate 26 by just a distance which corresponds to the gap between the nozzle plate 26 and the substrate 22. This second position is set to match the position at which the upper surface of the substrate 22, which is the object to be processed, is essentially present.

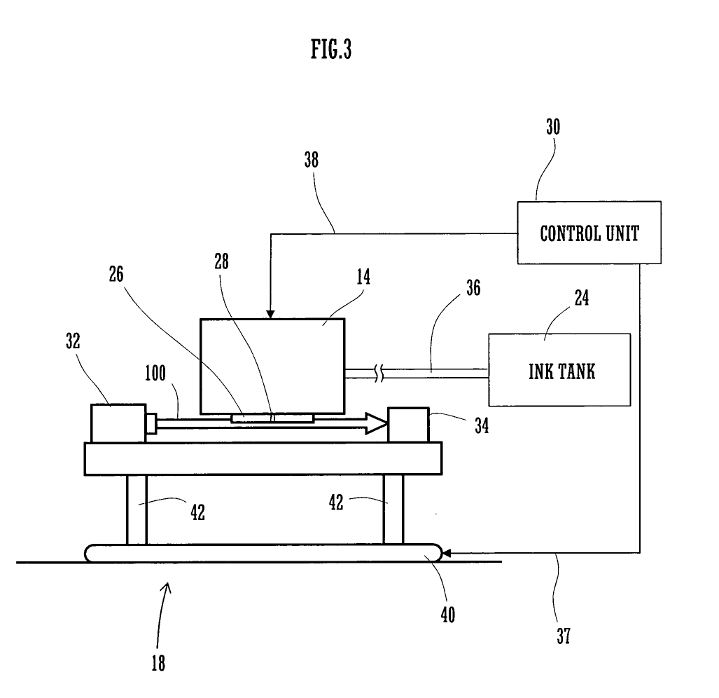

The support unit 40 is connected to the control unit 30 via a signal line 37. As shown in FIG. 3, this support unit 40 comprises a plurality of shafts 42 which support the bottom surface of the stand 35. The support unit 40 has a motor (not shown in the drawings), and it is arranged for the shafts 42 which are connected to the rotation shaft of this motor to extend or retract, each time this motor rotates forwards or backwards. As a result, the stand 35 raises or lowers each time the motor rotates forward or backward, and thereby the light emission unit 32 and the light reception unit 34 may be positioned as desired to any position between the first position and the second position.

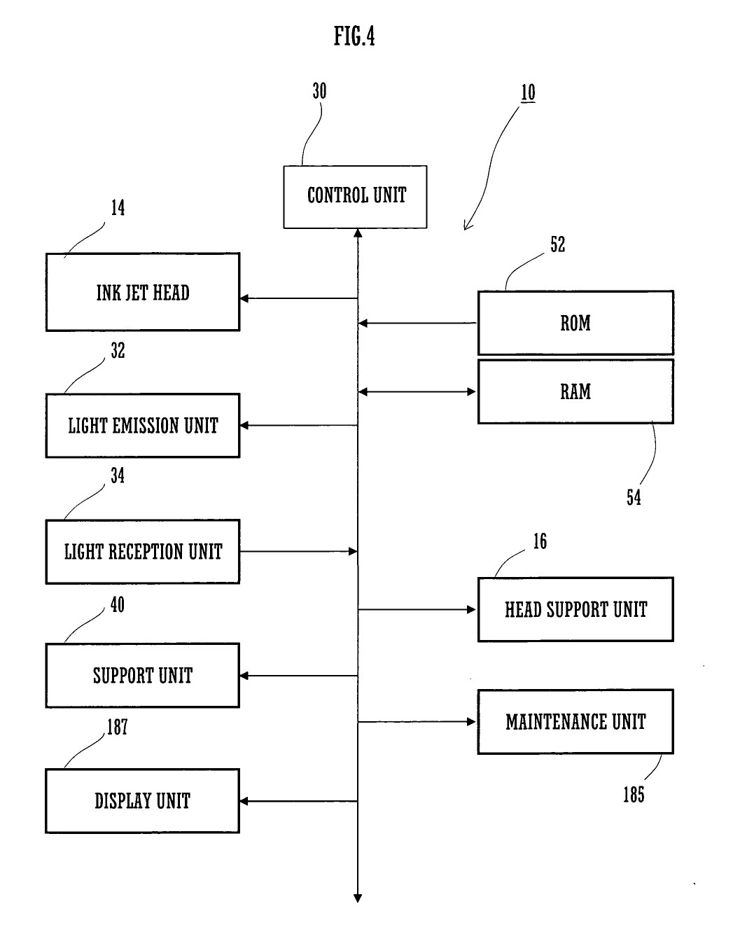

FIG. 4 is a block diagram showing the general structure of the ink jet application device 10. As shown in this figure, the control unit 30 is connected to a ROM 52 and to a RAM 54. The ROM 52 stores a plurality of programs which are necessary for the control operation of the control unit 30. And a decision table is also recorded in the ROM 52 which shows the correspondence relationship between the light reception state of the light reception unit 34 and the decision result.

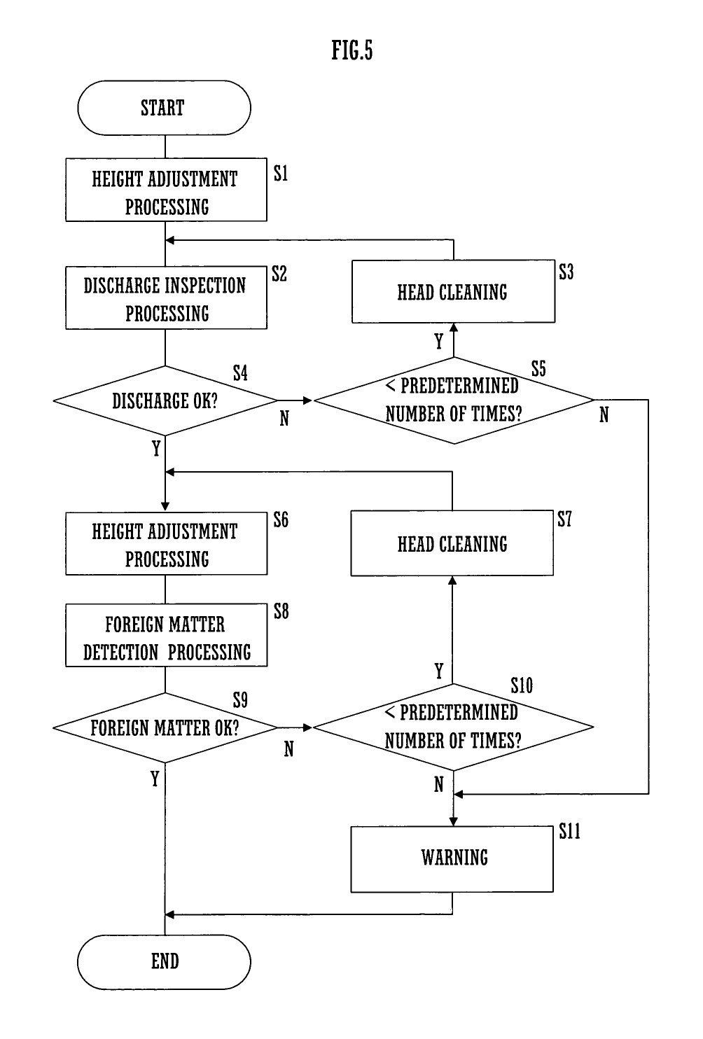

FIG. 5 is a flowchart showing operational steps performed by the control unit 30 during testing processing. The control unit performs testing processing before performing processing to discharge ink towards the substrate 22. First, the control unit 30 performs height adjustment processing of the stand 35 by operating the support unit 40 (a step S1). In this step S1, the control unit 30 adjusts the height of the stand 35 so that the distance from the nozzle surface to the optical axis of the test beam 100 becomes equal to the distance between the nozzle surface and the substrate 22.

Next, the control unit performs a step of inspecting the discharge (a step S2). In this discharge inspecting step S2, in the state in which ink is not being discharged from the ink jet head 14, the control unit 30 causes the light emission unit 32 to emit the detection beam 100, and detects the state of light reception by the light reception unit 34. In this embodiment, the control unit 30 detects the optical intensity of the light received by the light reception unit 34. However, the basis upon which the state of light reception is decided is not to be considered as being limited to optical intensity; it would also be acceptable to use the light reception width or the like as the parameter for deciding upon the state of light reception. The control unit 30 records the result of this detection in the RAM 54 as a first value. Next, in the state in which ink is being discharged from the ink jet head 14, the control unit 30 causes the light emission unit 32 to emit the detection beam 100, detects the state of light reception by the light reception unit 34, and records the result of this detection in the RAM 54 as a second value. If a plurality of the nozzle holes 28 are provided to a single ink jet head 14, then the step S2 is executed for all of these nozzle holes 28.

Next, the control unit makes a decision as to whether or not the discharge from the ink jet head 14 is adequate (a step S4). In this decision step S4, the control unit 30 compares together the first value and the second value, and decides that the discharge of ink is being performed in an adequate manner if the second value is less than 70% of the first value. If, on the other hand, the second value is greater than or equal to 70% of the first value, then it is decided that an anomaly is present in the discharge of ink. As causes of such an ink discharge anomaly, deviation of the discharge direction caused by a liquid drop or trash adhering to the nozzle surface, or ink non-discharge or the like, may be cited.

If in this decision step S4 it is decided that a discharge anomaly is present, then the control unit 30 causes the maintenance unit 185 of the maintenance unit 18 to perform head cleaning processing, limited to a predetermined number of times (steps S5 and S3). In this head cleaning processing of the step S3, processing to forcibly discharge ink from the nozzle hole 28, or processing for wiping the nozzle surface, is performed. If the discharge anomaly is not resolved even though head cleaning processing is performed the predetermined number of times, then the control unit 30 issues a warning display upon a display unit 187 (a step S11).

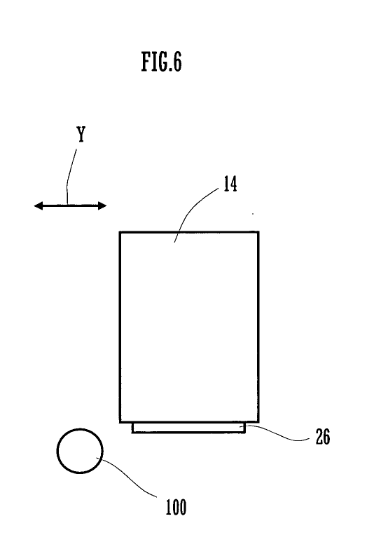

But if it has been decided, in the decision step S4, that the discharge from the ink jet head 14 is nominal, then the control unit 30 executes height adjustment processing (a step S6). In this step S6, by controlling the support unit 40, as shown in FIG. 3, the control unit 30 shifts the light emission unit 32 and the light reception unit 34 to their first position. Next, the control unit 30 performs foreign matter detection processing (a step S8). As shown in FIG. 6, this foreign matter detection processing of the step S8 is executed while shifting the ink jet head 14 along the Y axis. The reason for doing this is that the width of the detection beam 100 is smaller than the total width of the nozzle surface of the nozzle plate 26. By performing the foreign matter detection processing while shifting the ink jet head 14 along the Y axis as shown in FIG. 6, it becomes possible to decide upon the presence or absence of foreign matter over the entire area of the nozzle surface of the nozzle plate 26.

If in the decision step S9 it has been decided that foreign matter is present, then the control unit 30 causes the maintenance unit 185 of the maintenance unit 18 to perform head cleaning processing, limited to a predetermined number of times (steps S10 and S7). If the foreign matter is not eliminated even though head cleaning processing is performed the predetermined number of times, then the control unit 30 issues a warning display upon the display unit 187 (a step S11).

On the other hand, if in the decision step S9 no foreign matter is detected, then the control unit 30 outputs a signal to an external device to the effect that the reception attitude of the substrate 22 has been adjusted. In this embodiment, when the outputting of this signal has been completed, the substrate 22 is conveyed by a robot arm, so as to arrive over the stage 12.

Although, here, the discharge testing processing and the foreign matter detection processing were performed in that order, it should be understood that the sequence of discharge testing processing and foreign matter detection processing might be reversed.

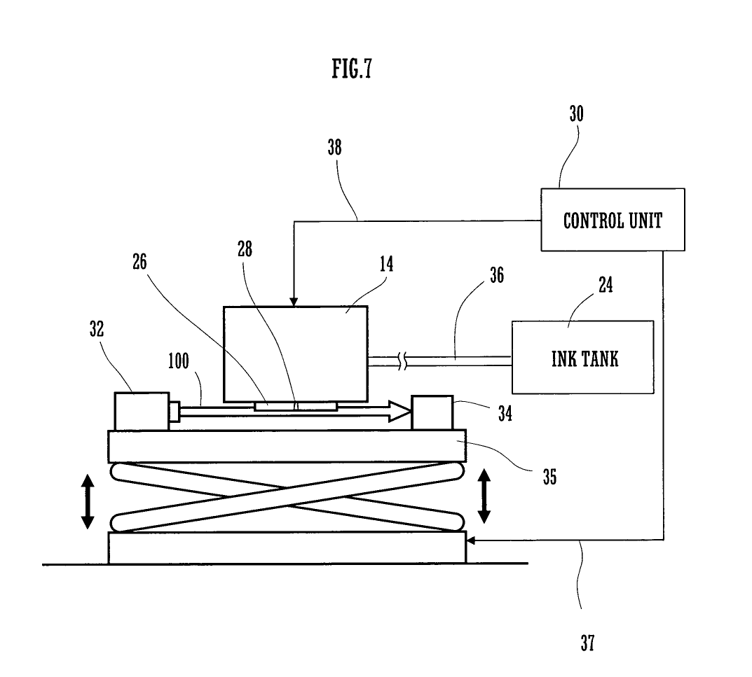

Moreover while, in the embodiment described above, a structure was employed in which the stand 35 was elevated or lowered each time the motor rotated forwards or backwards, it would also be acceptable to employ some other mechanism for elevating and lowering the stand 35. For example, as shown in FIG. 7, it would be possible to raise and lower the stand 35 by using a pantograph mechanism.

All of the features of the explanation of this embodiment given above are given by way of example, and must be viewed as not being limitative of the present invention in any way. The scope of the present invention is not defined by the embodiment described above, but only by the range of the Claims. Moreover, all changes which are equivalent in meaning and scope to the scope of the Claims, are intended to be included within the range of the present invention.

1. A liquid drop discharge head inspecting device configured to inspect a liquid drop discharge device having a liquid drop discharge head for discharging liquid drops from a nozzle hole provided in a nozzle surface towards an object to be processed, the liquid drop discharge head inspecting device comprising:
a detection unit including a light emission unit and a light reception unit, the light emission unit being configured to emit a detection beam in such a manner as to intersect path of progression of the liquid drops, the light reception unit being configured to receive the detection beam; and
a control unit configured to decide upon the presence or absence of obstruction between the light emission unit and the light reception unit, on the basis of state of light reception by the light reception unit;
wherein the detection unit is configured to perform emission and reception of the detection beam in at least a first position in which a portion of the detection beam is intercepted by the nozzle surface, and a second position positioned below the nozzle surface by just a distance corresponding to the gap between the nozzle surface and the object to be processed.

2. A liquid drop discharge head inspecting device according to claim 1, wherein the control unit detects poor discharge by the liquid drop discharge head on the basis of result of light reception by the light reception unit in the second position when the liquid drop discharge head discharges a liquid drop, and detects adherence of foreign matter to the nozzle surface of the liquid drop discharge head on the basis of result of light reception by the light reception unit in the first position when the liquid drop discharge head does not discharge any liquid drop.

3. A liquid drop discharge head inspecting device configured to inspect a liquid drop discharge device having a liquid drop discharge head for discharging liquid drops from a nozzle hole provided in a nozzle surface towards an object to be processed, the liquid drop discharge head inspecting device comprising:
a detection unit including a light emission unit and a light reception unit, the light emission unit being configured to emit a detection beam in such a manner as to intersect path of progression of the liquid drops, the light reception unit being configured to receive the detection beam;
a control unit configured to decide upon the presence or absence of obstruction between the light emission unit and the light reception unit, on the basis of state of light reception by the light reception unit; and
a support unit adapted to support the detection unit in such a manner as to enable the detection unit to move upwardly and downwardly;
wherein the support unit supports the light emission unit and the light reception unit in such a manner that the light emission unit and the light reception unit are reciprocable between a first position in which a portion of the detection beam is intercepted by the nozzle surface, and a second position positioned below the nozzle surface by just a distance corresponding to the gap between the nozzle surface and the object to be processed.

4. A liquid drop discharge head inspecting device according to claim 3, wherein the control unit detects poor discharge by the liquid drop discharge head on the basis of result of light reception by the light reception unit in the second position when the liquid drop discharge head discharges a liquid drop, and detects adherence of foreign matter to the nozzle surface of the liquid drop discharge head on the basis of result of light reception by the light reception unit in the first position when the liquid drop discharge head does not discharge any liquid drop.

5. A liquid drop discharge device including a liquid drop discharge head for discharging liquid drops from a nozzle hole provided in a nozzle surface towards an object to be processed, the liquid drop discharge device comprising:
a detection unit including a light emission unit and a light reception unit, the light emission unit being configured to emit a detection beam in such a manner as to intersect path of progression of the liquid drops, the light reception unit being configured to receive the detection beam; and
a control unit configured to decide upon the presence or absence of obstruction between the light emission unit and the light reception unit, on the basis of state of light reception by the light reception unit;
wherein the detection unit is configured to perform emission and reception of the detection beam in at least a first position in which a portion of the detection beam is intercepted by the nozzle surface, and a second position positioned below the nozzle surface by just a distance corresponding to the gap between the nozzle surface and the object to be processed.

6. A liquid drop discharge device according to claim 5, wherein the control unit detects poor discharge by the liquid drop discharge head on the basis of result of light reception by the light reception unit in the second position when the liquid drop discharge head discharges a liquid drop, and detects adherence of foreign matter to the nozzle surface of the liquid drop discharge head on the basis of result of light reception by the light reception unit in the first position when the liquid drop discharge head does not discharge any liquid drop.

7. A liquid drop discharge device including a liquid drop discharge head for discharging liquid drops from a nozzle hole provided in a nozzle surface towards an object to be processed, the liquid drop discharge device comprising:
a detection unit including a light emission unit and a light reception unit, the light emission unit being configured to emit a detection beam in such a manner as to intersect path of progression of the liquid drops, the light reception unit being configured to receive the detection beam;
a control unit configured to decide upon the presence or absence of obstruction between the light emission unit and the light reception unit, on the basis of state of light reception by the light reception unit; and
a support unit adapted to support the detection unit in such a manner as to enable the detection unit move upwardly and downwardly;
wherein the support unit supports the light emission unit and the light reception unit in such a manner that the light emission unit and the light reception unit are reciprocable between a first position in which a portion of the detection beam is intercepted by the nozzle surface, and a second position positioned below the nozzle surface by just a distance corresponding to the gap between the nozzle surface and the object to be processed.

8. A liquid drop discharge device according to claim 7, wherein the control unit detects poor discharge by the liquid drop discharge head on the basis of result of light reception by the light reception unit in the second position when the liquid drop discharge head discharges a liquid drop, and detects adherence of foreign matter to the nozzle surface of the liquid drop discharge head on the basis of result of light reception by the light reception unit in the first position when the liquid drop discharge head does not discharge any liquid drop.
